(19) United States
(12) Patent Application Publication
(10) Pub. No.: US 2008/0006234 A1
(43) Pub. Date: Jan. 10, 2008

(54) Fastening structure for a cylinder block

(76) Inventors: Tadafumi Furukawa, Aichi-ken (JP); Taku Kogure, Aichi-ken (JP)

Correspondence Address: MORGAN & FINNEGAN, L.L.P., 3 World Financial Center, New York, NY, 10281-2101, US

(21) Appl. No.: 11/823,938

(22) Filed: Jun. 29, 2007

(30) Foreign Application Priority Data
Jul. 5, 2006 (JP) 2006-185416

(51) Int. Cl. F02F 7/00

(52) U.S. Cl. 123/195 R

(57) ABSTRACT

A bulkhead is provided with a bulkhead through-hole penetrating the bulkhead and a screw hole extending from a lower part of the bulkhead toward the bulkhead through-hole so as to communicate with the bulkhead through-hole. An internal thread portion is formed along the inner peripheral surface of the screw hole. A shaft portion of a bolt, which is inserted into a bolt insertion hole penetrating a crank cap from a lower part thereof to an upper part thereof, is threaded into the screw hole such that an external thread portion of the bolt is threadingly engaged with the internal thread portion. As a result, the crank cap is fastened to the lower part of the bulkhead. Both the tip surface of the bolt and apart of the external thread portion protrude into the bulkhead through-hole. The bulkhead through-hole has a diameter larger than that of the opening of the screw hole.

### BACKGROUND OF THE INVENTION

1. Field of the Invention

The present invention relates to a fastening structure for a cylinder block, and more particularly, to a fastening structure for fastening a crank cap to each bulkhead of a cylinder block by means of screw members in an internal combustion engine.

2. Description of the Related Art

JP 10-122042 A discloses a cylinder block structured such that a crank cap is fastened to a lower part of each bulkhead which separates two adjacent cylinders from each other by means of bolts. FIG. 6 shows a cross-section of such a cylinder block. In a bulkhead 30, a bulkhead through-hole 36 is formed to penetrate the bulkhead 30 separating two adjacent cylinders from each other, and a screw hole 31 extending from the lower part of the bulkhead 30 is formed so as to communicate with the bulkhead through-hole 36. By inserting a bolt 33 through a crank cap 38 into the screw hole 31, the crank cap 38 is fastened to the lower part of the bulkhead 30. FIG. 7 shows an enlarged cross-section of a state where the bolt 33 is inserted into the screw hole 31 in such a cylinder block. An internal thread portion 32 is formed along the inner peripheral surface of the screw hole 31 formed in the bulkhead 30, and the bolt 33 is threaded into the screw hole 31 such that an external thread portion 35 of the bolt 33 is threadingly engaged with the internal thread portion 32. A tip surface 33a of the bolt 33 does not protrude into the bulkhead through-hole 36, and a first external thread portion 35a connected to the tip surface 33a is threadingly engaged with the internal thread portion 32.

In such a cylinder block, stress acting in a longitudinal direction of the bolt 33 is generated in the vicinity of a fastening portion of the bolt 33 due to explosive load deriving from combustion in the engine. The stress is transmitted to the bolt 33 and the cylinder block respectively. However, the bolt 33 and the cylinder block are made of different materials respectively, so the stress tends to concentrate on the end of the coupling between them, namely, near the end of thread engagement 37 (FIG. 6) at the tip of the bolt 33. Furthermore, tensile stresses (indicated by arrows C of FIG. 7) acting in an axial direction of the bolt 33 are mainly applied to the root of the internal thread 32a in the vicinity of the end of thread engagement 37 in particular. There is a problem in that fatigue fracture tends to occur from the root of the internal thread 32a due to the tensile stresses applied thereto near the end of thread engagement 37, which are repeatedly generated due to the explosive load. In particular, recent engines often employ aluminium die-cast cylinder blocks in order to achieve output increases, weight reductions, productivity improvements, and cost reductions. In this case, there is a greater difference in rigidity between a bolt and a cylinder block than in a case where a cast-iron cylinder block is employed, so fatigue fracture from the root of the internal thread 32a is more likely to occur.

### SUMMARY OF THE INVENTION

The present invention has been made to solve the problem stated above, and it is therefore an object of the present invention to provide a fastening structure for a cylinder block with increased strength in the fastening portion upon fastening a crank cap to each bulkhead of the cylinder block by means of screw members.

A fastening structure for a cylinder block, which fastens a crank cap by a screw member to a lower part of each bulkhead separating adjacent cylinders in a cylinder block from each other, comprises:

a through-hole portion formed so as to penetrate the bulkhead; and

a screw hole extending from the lower part of the bulkhead toward the through-hole portion and communicating with the through-hole portion, wherein:

the through-hole portion has a size large enough to contain an axial projection of the screw hole; and

the screw member is threaded into the screw hole such that a tip surface of the screw member and a part of an external thread portion of the screw member protrude into the through-hole portion, thereby fastening the crank cap to the lower part of the bulkhead.

### BRIEF DESCRIPTION OF THE DRAWINGS

FIG. 1 is a cross-sectional view of a cylinder block according to a first embodiment of the present invention;

FIG. 2 is an enlarged cross-sectional view of a fastening portion between a crank cap and a bulkhead in the cylinder block according to the first embodiment of the present invention;

FIG. 3 is an enlarged cross-sectional view of a screw fastening portion in the cylinder block according to the first embodiment of the present invention;

FIG. 4 is an explanatory diagram showing the principle of reducing stress in the cylinder block according to the first embodiment of the present invention;

FIG. 5 is an enlarged cross-sectional view of a fastening portion between a crank cap and a bulkhead in a cylinder block according to a second embodiment of the present invention;

FIG. 6 is a cross-sectional view of a screw fastening portion in a conventional cylinder block; and

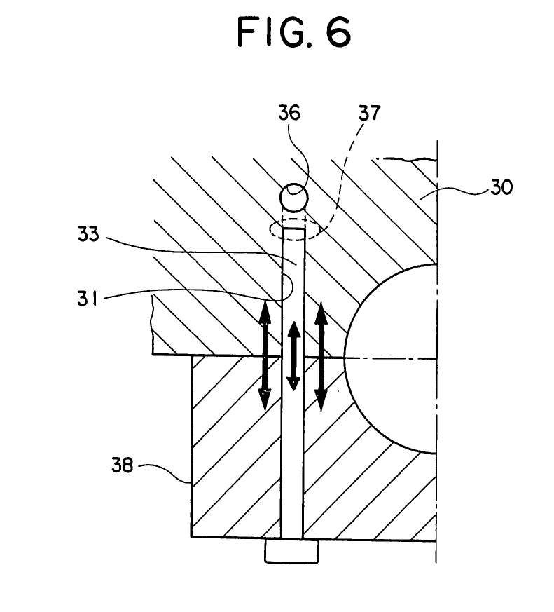

FIG. 7 is an enlarged cross-sectional view of the screw fastening portion in the conventional cylinder block.

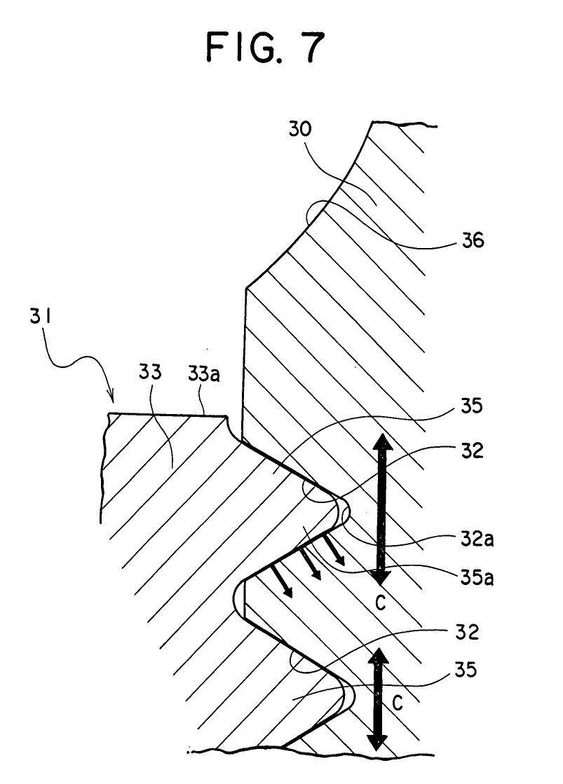

### DETAILED DESCRIPTION OF THE PREFERRED EMBODIMENTS

Embodiments of the present invention will be described below with reference to the accompanying drawings.

### First Embodiment

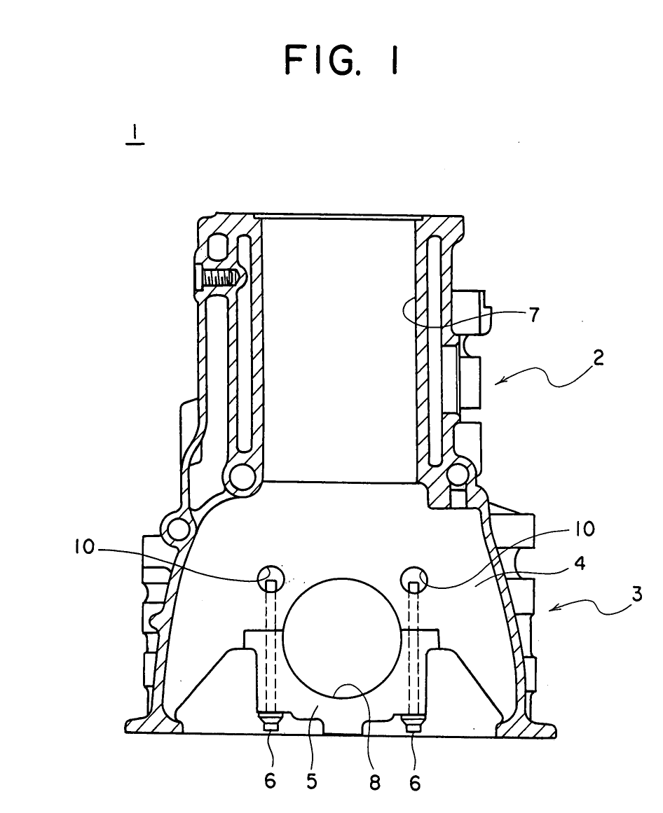

FIG. 1 shows a cross-section of a cylinder block according to the first embodiment of the present invention. A cylinder block 1 of an internal combustion engine includes a cylinder portion 2 and a crankcase portion 3 provided integrally on a lower part of the cylinder portion 2. A cylinder bore 7 serving as a cylinder of the internal combustion engine is formed inside the cylinder portion 2. A bulkhead 4 is provided inside the crankcase portion 3. The bulkhead 4 separates the cylinder bore 7 from another cylinder bore (not shown) adjacent thereto. A crank cap 5 is fastened to a lower part of the bulkhead 4 by means of two bolts 6. A support portion 8 for supporting a crankshaft (not shown) is formed between the two bolts 6 by the bulkhead 4 and the crank cap 5. It should be noted herein that the bolts 6 constitute screw members. Furthermore, in the bulkhead 4, bulkhead through-holes 10 are provided in the vicinity of the tip portions of the two bolts 6 respectively. The bulkhead through-holes 10 are through-hole portions penetrating the bulkhead 4 and communicating between the cylinder bore 7 and another cylinder bore (not shown) adjacent to the cylinder bore 7. Each of the tip portions of the bolts 6 protrude into a corresponding one of the bulkhead through-holes 10.

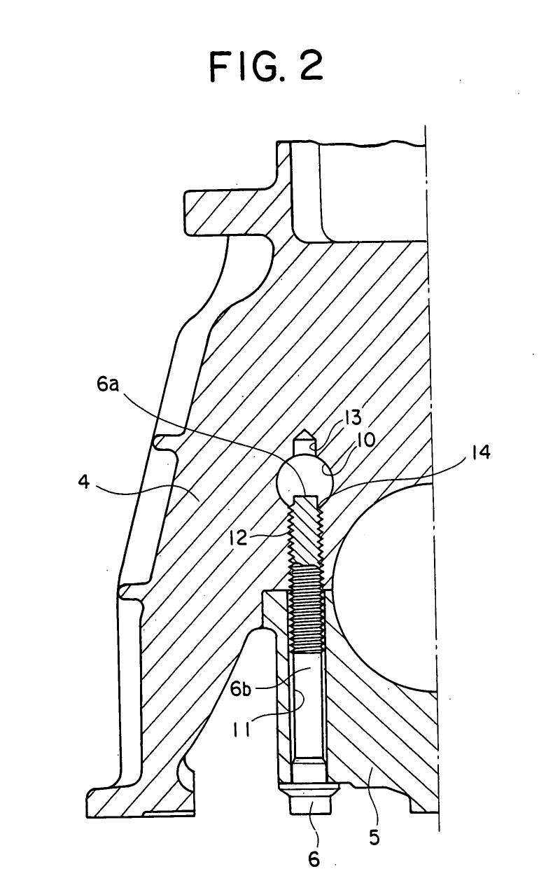

FIG. 2 shows an enlarged cross-section of a fastening portion between the crank cap 5 and the bulkhead 4. A bolt insertion hole 11 penetrating the crank cap 5 from a lower part thereof to an upper part thereof is formed in the crank cap 5, and a shaft portion 6b of each of the bolts 6 is inserted into the bolt insertion hole 11. Screw holes 13 extending from a lower part of the bulkhead 4 toward each bulkhead through-hole 10 and communicating with each bulkhead through-hole 10 are formed in the bulkhead 4. An internal thread portion 12 is formed along the inner peripheral surface of each screw hole 13. The shaft portion 6b of the bolt 6 inserted into the bolt insertion hole 11 is further inserted into the screw hole 13 so that an external thread portion 14 is threadingly engaged with the internal thread portion 12. As a result, the crank cap 5 is fastened to the lower part of the bulkhead 4. It should be noted that a tip surface 6a of the bolt 6 and a part of the external thread portion 14 protrude into the bulkhead through-hole 10.

The bulkhead through-hole 10 has a diameter larger than that of an opening of the screw hole 13. In other words, the bulkhead through-hole 10 is large enough to contain an axial projection of the screw hole 13.

Next, stress generated in the cylinder block according to the first embodiment of the present invention due to an explosive load derived from combustion in the engine will be described.

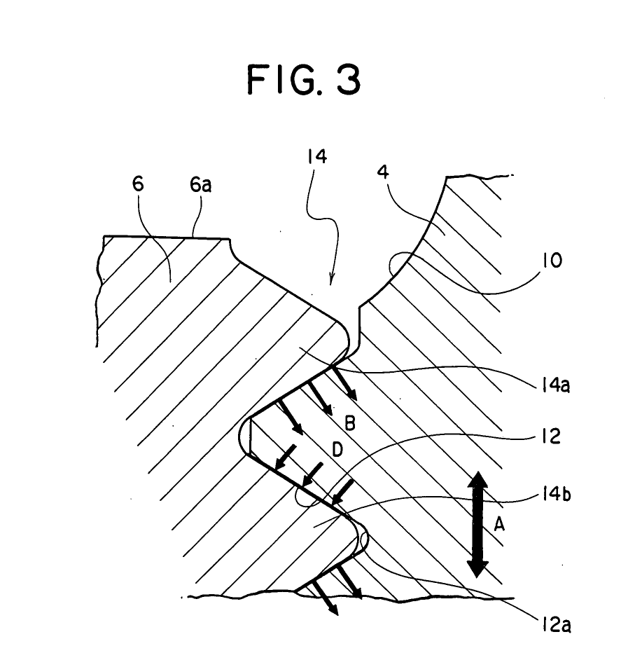

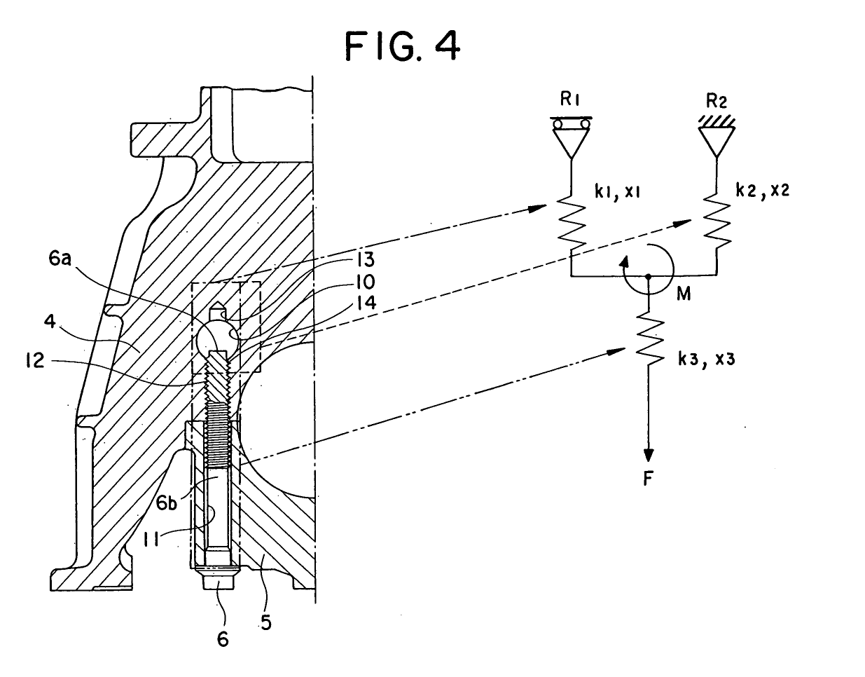

When combustion occurs in a cylinder, stress is generated in the longitudinal direction of the bolt 6 (as indicated by an arrow A), as shown in FIG. 3, due to the explosive load. This generated stress circumvents the bulkhead through-hole 10. Because the diameter of the bulkhead through-hole 10 is larger than that of an opening of the screw hole 13, the stress is less likely to concentrate on the vicinity of the end of thread engagement at the tip of the bolt 6, namely, the vicinity of the root of the internal thread 12a located closest to the side of the bulkhead through-hole 10, with which the external thread portion 14 of the bolt 6 is engaged. With respect to the foregoing description, FIG. 4 is shown in order to add supplemental remarks. FIG. 4 schematically shows a relationship among the explosive load and forces applied to the peripheries of the screw hole 13 and the bulkhead through-hole 10. The force applied to the root of the internal thread 12a at the end of thread engagement of the bolt 6 in the axial direction of the screw hole 13 due to the explosive load F is denoted by R1, and the force applied to the other portions is denoted by R2. Furthermore, elastic coefficients and deformation amounts of regions on which the respective forces R1 and R2 act in the main are denoted by k1 and k2, and x1 and x2, respectively. Providing the bulkhead through-hole 10 decreases the rigidity above the screw hole 13 and thus decreases the values of the elastic coefficient k1 and the force R1 applied to the end of thread engagement of the bolt 6. The force R2 applied to the other portions increases correspondingly, and a moment M for maintaining the deformation amounts x1 and x2 equal acts as shear stress. Because the force R2 and the moment M which are increased are not closely related to the stress acting on the root of the internal thread at the end of thread engagement of the bolt 6, the stress concentration on the root of the internal thread at the end of thread engagement of the bolt 6 is relieved.

Moreover, when the value of the elastic coefficient k1 is reduced, the values of the deformation amounts x1 and x2 are increased and thus the periphery of the screw hole 13 is deformed in the case where the value of the elastic coefficient k2 is not very large. In the first embodiment of the present invention, because the bulkhead through-hole 10 has a size large enough to contain at least the axial projection of the screw hole 13 and is formed individually for each of the bolts 6, a region B is ensured of sufficient are a, so that the elastic coefficient k2 is also ensured of a sufficiently large value. Therefore, the problem as described above is not caused.

Accordingly, the stress concentration in the vicinity of the root of the internal thread 12a located closest to the side of the bulkhead through-hole 10, with which the external thread portion 14 of the bolt 6 is engaged, is less likely to occur as compared with a case where the bulkhead 4 has no bulkhead through-hole 10.

Furthermore, both the tip surface 6a of the bolt 6 and a first external thread portion 14a connected to the tip surface 6a protrude into the bulkhead through-hole 10, and a second external thread portion 14b connected to the first external thread portion 14a is threadingly engaged with the internal thread portion 12. Because the root of the internal thread at the end of thread engagement of the bolt 6 is not present due to such construction, the stress concentration is relieved. As a supplementary explanation, in the first embodiment, as shown in FIG. 3, the root of the internal thread 12a located closest to the side of the bulkhead through-hole 10 also receives a downward load from thereabove, namely, from the first external thread portion 14a at the side of the tip of the bolt 6 (as indicated by arrows B). Thus, in the root of the internal thread 12a located closest to the side of the bulkhead through-hole 10 with which the external thread portion 14 of the bolt 6 is engaged as well, a part of the stress is counterbalanced by the load indicated by arrows D as is the case with the other roots of an internal thread. As a result, the excess stress concentration in the vicinity of the root of the internal thread 12a is removed.

As described above, because the stress generated due to the explosive load resulting from combustion in the engine circumvents the bulkhead through-hole 10 by providing the bulkhead through-hole 10 having a diameter larger than that of the opening of the screw hole 13 so as to penetrate the bulkhead 4, the stress is unlikely to concentrate in the vicinity of the root of the internal thread 12a located closest to the side of the bulkhead through-hole 10 with which the external thread portion 14 of the bolt 6 is engaged. As a result, the strength of the fastening portion of each of the bolts 6 can be increased when the crank cap 5 is fastened to the lower part of the bulkhead 4 by means of the bolts 6.

Furthermore, because the root of the internal thread at the end of thread engagement of the bolt 6 is eliminated by both the tip surface 6a of the bolt 6 and the first external thread portion 14a connected to the tip surface 6a protruding into the bulkhead through-hole 10, the stress concentration is removed and thus the strength of the fastening portion of each of the bolts 6 can be increased.

Moreover, because the strength of the fastening portion of each of the bolts 6 can be increased even in the case of an aluminium die-cast cylinder block, output increases and weight reductions can be realized.

### Second Embodiment

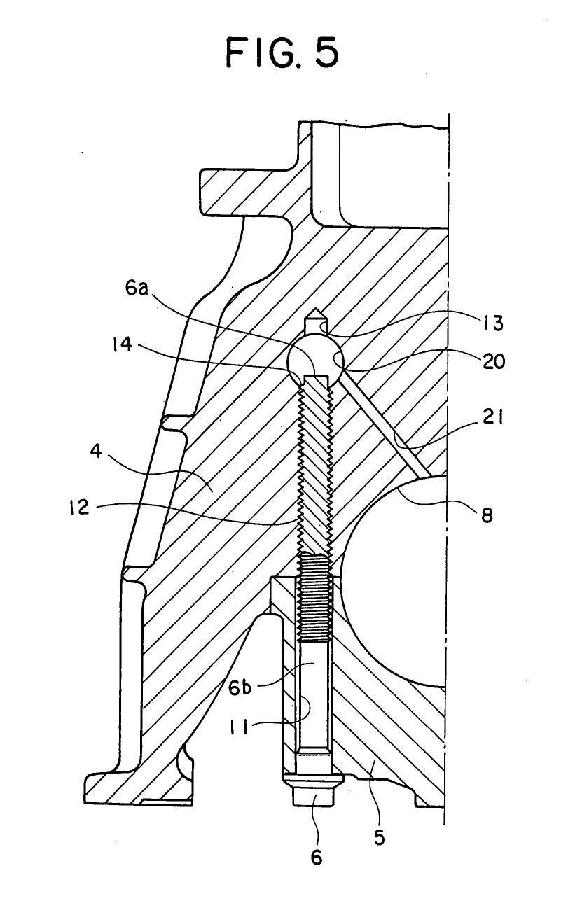

Next, a fastening structure for a cylinder block according to the second embodiment of the present invention will be described with reference to FIG. 5. In the following embodiment, reference symbols identical to those of FIGS. 1 to 4 denote the same components or similar components respectively, so no detailed description of such components will be given below.

In the fastening structure for the cylinder block according to the second embodiment of the present invention, unlike the first embodiment of the present invention, an existing oil hole in the bulkhead 4 is used as the through-hole portion.

As shown in FIG. 5, the bolt insertion hole 11 penetrating the crank cap 5 from the lower part thereof to the upper part thereof is formed in the crank cap 5, and the shaft portion 6b of the bolt 6 is inserted into the bolt insertion hole 11. An oil passage, which is provided in a crankcase (not shown) and through which oil flows, penetrates the bulkhead 4 and a circular oil hole 20 therefore is formed in the bulkhead 4. The oil hole 20 and the support portion 8 are communicated with each other via an oil supply channel 21. The screw hole 13 extending from the lower part of the bulkhead 4 toward the oil hole 20 so as to communicate with the oil hole 20 is also formed in the bulkhead 4. The internal thread portion 12 is formed along the inner peripheral surface of the screw hole 13. The shaft portion 6b of the bolt 6 inserted into the bolt insertion hole 11 is further threaded into the screw hole 13 such that the external thread portion 14 is threadingly engaged with the internal thread portion 12. As a result, the crank cap 5 is fastened to the lower part of the bulkhead 4. It should be noted that both the tip surface 6a of the bolt 6 and a part of the external thread portion 14 protrude into the oil hole 20. The oil hole 20 has a diameter larger than that of the opening of the screw hole 13. In other words, the oil hole 20 has an opening large enough to contain the axial projection of the screw hole 13.

As described above, because the stress generated due to the explosive load resulting from combustion in the engine circumvents the oil hole 20 by using the oil hole 20 as the through-hole portion, the stress is unlikely to concentrate in the vicinity of the root of the internal thread 12a located closest to the side of the oil hole 20 with which the external thread portion 14 of the bolt 6 is engaged. Furthermore, as the root of the internal thread at the end of thread engagement of the bolt 6 is not present because both the tip surface 6a of the bolt 6 and the first external thread portion 14a connected to the tip surface 6a protrude into the oil hole 20, the stress concentration is removed and thus the strength of the fastening portion of each of the bolts 6 can be increased. As a result, an effect similar to that of the first embodiment can be achieved. In addition, because the bulkhead 4 is already provided with the oil hole 20, the fastening structure for the cylinder block according to the second embodiment of the present invention can be realized by forming the screw hole 13 in accordance with the position of the oil hole 20. Therefore, a reduction in manufacturing costs and simplification of the manufacturing process can be achieved.

The bulkhead through-hole 10 and the oil hole 20 have a circular shape in the first embodiment and the second embodiment respectively. However, the present invention is not limited to such constructions. The bulkhead through-hole 10 or the oil hole 20 may have any shape as long as the opening thereof is large enough to contain the axial projection of the screw hole 13. In addition, the bulkhead through-hole 10 or the oil hole 20 may be designed appropriately in any size in accordance with the size or shape of the engine as long as the axial projection of the screw hole 13 can be contained within the size.

What is claimed is:

1. A fastening structure for a cylinder block, which fastens a crank cap by a screw member to a lower part of each bulkhead separating adjacent cylinders in a cylinder block from each other, the fastening structure comprising:
a through-hole portion formed so as to penetrate the bulkhead; and
a screw hole extending from the lower part of the bulkhead toward the through-hole portion and communicating with the through-hole portion, wherein:
the through-hole portion has a size large enough to contain an axial projection of the screw hole; and
the screw member is threaded into the screw hole such that a tip surface of the screw member and a part of an external thread portion of the screw member protrude into the through-hole portion, thereby fastening the crank cap to the lower part of the bulkhead.

2. A fastening structure for a cylinder block according to claim 1, wherein the through-hole portion is a bulkhead through-hole formed so as to penetrate the bulkhead and thus communicate between the adjacent cylinders.

3. A fastening structure for a cylinder block according to claim 1, wherein the through-hole portion is an oil hole formed by an oil passage penetrating the bulkhead through which oil flows.
